(19) United States
(12) Patent Application Publication
(10) Pub. No.: US 2014/0143688 A1
(43) Pub. Date: May 22, 2014

(54) ENHANCED NAVIGATION FOR TOUCH-SURFACE DEVICE

(71) Applicant: MICROSOFT CORPORATION, Redmond, WA (US)

(72) Inventors: Zhitao Hou, Beijing (CN); Xiao Liang, Beijing (CN); Dongmei Zhang, Bellevue, WA (US); Haidong Zhang, Beijing (CN)

(73) Assignee: MICROSOFT CORPORATION, Redmond, WA (US)

(21) Appl. No.: 13/681,243

(22) Filed: Nov. 19, 2012

(51) Int. Cl. G06F 3/01

(52) U.S. Cl. CPC G06F 3/017
USPC 715/760

(57) ABSTRACT

An enhanced navigation system detects a predetermined input gesture from a user and presents one or more gesture panels at pre-designated positions on a display of a touch-surface device or positions determined based on where a user is likely to hold the device. The user may navigate content of the application currently presented in the display by providing one or more input gestures within the one or more gesture panels, thus saving the user from moving his/her hands around the display of the touch-surface device while holding the touch-surface device. The enhanced navigation system further enables synchronize one or more gesture definitions with a cloud computing system and/or one or more other devices.

### BACKGROUND

With the advance of mobile technologies, increasing numbers of people use mobile devices to perform a variety of daily activities that were previously performed using desktop computers. For example, many people use touch-surface devices (such as tablet or slate computers, mobile phones, etc.) to browse the Internet. However, since most of the Web content on the Internet, for example, has been designed originally to be presented using computers equipped with mice and keyboards, navigation of the Web content using a touch-surface device, though feasible, is inconvenient to a user. For example, the user often needs to move his/her hand around the touch-surface device in order to select and actuate navigation controls and/or hyperlinks displayed in a web page. Given that a display estate of a touch-surface device is normally small, moving his/her hand around to select and/or actuate a desired control or hyperlink may prove inconvenient to the user. This is especially true when the user needs to use one or both of his/her hands to hold the device.

### SUMMARY

This summary introduces simplified concepts of enhanced navigation for a touch-surface device, which are further described below in the Detailed Description. This summary is not intended to identify essential features of the claimed subject matter, nor is it intended for use in limiting the scope of the claimed subject matter.

This application describes example embodiments of enhanced navigation for a touch-surface device. In one embodiment, a touch-surface device may display content of an application (such as a web browser application) on a display thereof. The device or the application may include a control through which a user may initiate a transparent gesture panel on top of the application at a position of the display of the touch-surface device. The gesture panel accepts one or more user gestures from the user and enables the user to navigate the content of the application without moving his/her hand around the display of the touch-surface device.

In some embodiments, the user may further allow to define a gesture relationship between a user gesture and an action or command. The device or the application may provide a control that the user may activate to open a window to guide the user to define the gesture relationship. In one embodiment, after the gesture relationship is defined, the device or the application may store information of the gesture relationship in the device and/or upload the information to one or more servers over a network.

Additionally or alternatively, in some embodiments, the user may download a new gesture relationship from the one or more servers to the device. In one embodiment, if a type and/or an operation mechanism of the device or an application of the device is/are different from a device or an application for which the new gesture relationship is initially defined, the one or more servers may perform an adaptation of the new gesture relationship to the device and/or the application of the user. Upon adaptation, the one or more servers may send the adapted gesture relationship to the device of the user, which may store information of the adapted gesture relationship for use by the device or the application.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment including an example enhanced navigation system.

FIG. 2 illustrates the example client device including the example enhanced navigation system of FIG. 1 in more detail.

FIG. 3A illustrates an example content navigation input gesture for scrolling down a web page.

FIG. 3B illustrates an example content navigation input gesture for scrolling up a web page.

FIG. 3C illustrates an example content navigation input gesture for browsing a next article or thread.

FIG. 3D illustrates an example content navigation input gesture for browsing a previous article or thread.

FIG. 3E illustrates an example content navigation input gesture to refresh a web page.

FIG. 3F illustrates an example content navigation input gesture for a command that has been defined by a user or by an enhanced navigation system.

FIG. 4 illustrates an example method of enhanced navigation.

FIG. 5 illustrates an example method of gesture definition download.

FIG. 6 illustrates an example method of gesture definition synchronization.

### DETAILED DESCRIPTION

### Overview

As noted above, contents of most existing software programs or applications today are originally designed or tailored to be viewed and navigated using conventional computers (e.g., desktop and laptop computers, etc.) that are equipped with mice and keyboards. If a user uses a touch-surface device (e.g., a slate or tablet computer) to browse a web page using a web browser application, for example, the user is forced to move around his/her hand over the touch-surface device in order to select a control or hyperlink on the web page for navigation of the web page and/or a website thereof. This may inconvenience the user, especially when the user needs to hold the touch-surface device using his/her hands.

This disclosure describes an enhanced navigation system, which enables a user to navigate content presented on an application with minimal user gesture, finger or hand movement. In one embodiment, a user gesture may include, but is not limited to, a touch gesture or input using one or more fingers or pointing devices on a display of a touch-surface device. In one embodiment, the enhanced navigation system may present a gesture panel which may be overlaid, for example, on top of a part of the content or the application at a position in a display of a touch-surface device in response to detecting a predefined user gesture of the user. The enhanced navigation system may determine the position where the gesture panel may be overlaid by, for example, determining a location where the user is likely to hold the touch-surface device and designating, based on the determined location, the position where the gesture panel is to be presented. In one embodiment, the enhanced navigation system may achieve presentation of the gesture panel by injecting a program to the application. For example, if the application is a web browser application, the enhanced navigation system may inject a JavaScript program, for example, to a web page of a website that is currently viewed in the web browser application.

Upon presentation, the enhanced navigation system may accept one or more gestures from the user via the gesture panel and navigate the content and/or the application for the user based on the one or more user gestures detected in the gesture panel. In some embodiments, the gesture panel may be transparent, allowing the user to view the part of the content or the application that is located under the gesture panel while enabling the user to input a user gesture within the gesture panel.

Furthermore, in one embodiment, the enhanced navigation system may allow the user to define a new gesture definition or relationship (which describes a mapping between a user gesture and an action or command) for a particular device and/or application, and transfer (or synchronize) the new gesture definition or relationship to another device and/or application. In one embodiment, the enhanced navigation system may achieve this operation of transfer or synchronization when the two devices at issues are brought within a predetermined proximity with each other and the user has requested the transfer operation through one of the two devices. In one embodiment, gestures defined by a user on one device (e.g., a mobile phone) may be transferred or synchronized to other devices (e.g., a tablet, a family member's mobile phone or tablet, etc.) associated with the user or an account of the user.

Additionally or alternatively, the enhanced navigation system may upload a definition of the gesture relationship defined for one device or application to one or more servers (or a cloud computing system) which may then enable downloading of the definition of the gesture relationship to another device or an application of the other device. In an event that the two devices (and/or applications) are different from each other in types and/or operation mechanisms, the one or more servers may adapt a new definition describing the same gesture relationship but to be acceptable to and/or compatible with the other device (and/or the application of the other device). Upon adaptation, the one or more servers may send and/or synchronize the new definition of the same gesture relationship to the other device.

The described system enables a user to navigate an application and/or content of the application presented in a display of touch-surface device with minimal finger and/or hand movement of the user. The enhanced navigation system further allows the user to transfer or synchronize a definition of a gesture relationship from one device to another, and cooperate with a cloud computing system, for example, to achieve this transfer and perform an adaptation (if needed) of the gesture relationship to the other device.

In the examples described herein, the enhanced navigation system detects a gesture from a user at a device, presents a gesture panel, accepts one or more navigation gestures within the gesture panel, enables navigation of an application and/or content of the application, and enables definition and/or transfer of a gesture relationship definition to a server or another device. However, in other embodiments, these functions may be performed by multiple separate systems or services. For example, in one embodiment, a detection service may detect a gesture from the user, while a separate service may present a gesture panel and accept one or more navigation gestures within the gesture panel. A navigation service may enable navigation of an application and/or content of the application, and yet another service may enable definition and/or transfer of a gesture relationship definition to a server in a cloud computing system and/or another device.

Furthermore, although in the examples described herein the enhanced navigation system may be implemented at least in part as a plug-in or add-on program to an application (such as a JavaScript program for a web browser application, for example), in other embodiments, the enhanced navigation system may be implemented as a service provided in a server over a network. Furthermore, in some embodiments, the enhanced navigation system may be implemented as a background process, a part of an operating system or application providing support to a plurality of applications (e.g., a web browser application, a text editor application, a news application, etc.). Additionally or alternatively, in some embodiments, the enhanced navigation system may be one or more services provided by one or more servers in a network or in a cloud computing architecture.

The application describes multiple and varied implementations and embodiments. The following section describes an example environment that is suitable for practicing various implementations. Next, the application describes example systems, devices, and processes for implementing an enhanced navigation system.

### Exemplary Environment

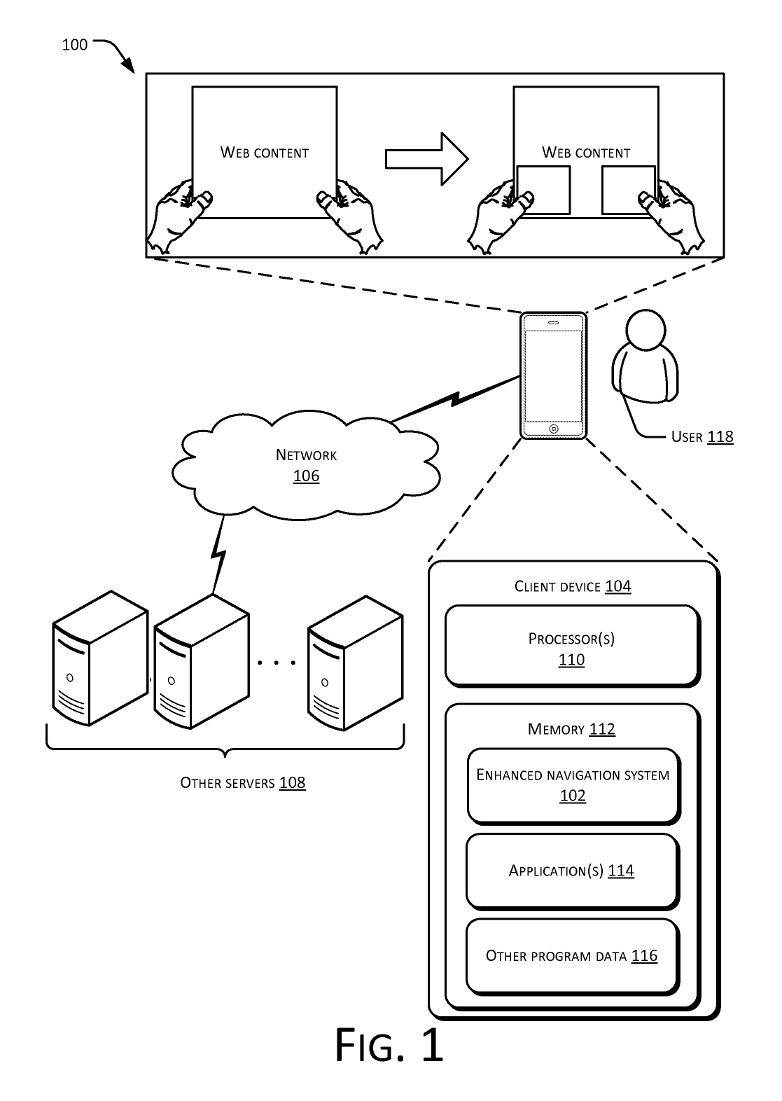

FIG. 1 illustrates an exemplary environment 100 that implements an enhanced navigation system 102. In one embodiment, the environment 100 may include a client device 104. In this example, the enhanced navigation system 102 is included in the client device 104. In some embodiments, the environment 100 may further include a network 106 and one or more servers 108. The device 104 and/or the enhanced navigation system 102 may communicate data with the one or more servers 108 via the network 106.

Although in this example, the enhanced navigation system 102 is described to be a system included in the client device 104, in some embodiments, functions of the enhanced navigation system 102 may be included and distributed among the client device 104 and/or the one or more other servers 108. For example, the client device 104 may include part of the functions of the enhanced navigation system 102 while other functions of the enhanced navigation system 102 may be included in one or more other servers 108. Furthermore, in some embodiments, the enhanced navigation system 102 may be included in one or more third-party servers, e.g., other servers 108, that may or may not be a part of a cloud computing system or architecture.

The client device 104 may be implemented as any of a variety of conventional computing devices equipped with displays of touch screens, touch surfaces or touch pads, etc., that enable users to manipulate content presented on the displays through touch inputs of the users. By way of example and not limitation, the client device 104 may include, for example, a mainframe computer, a server, a notebook or portable computer, a handheld device, a netbook, an Internet appliance, a tablet or slate computer, a mobile device (e.g., a mobile phone, a personal digital assistant, a smart phone, etc.), etc. or a combination thereof, that includes a touch screen, a touch surface or a touch pad.

The network 106 may be a wireless or a wired network, or a combination thereof. The network 106 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

In one embodiment, the client device 104 includes one or more processors 110 coupled to memory 112. The memory 112 includes one or more applications or services 114 (e.g., web applications or services, text editor applications or services, etc.) and other program data 116. The memory 112 may be coupled to, associated with, and/or accessible to other devices, such as network servers, routers, and/or the other servers 108.

In one embodiment, a user 118 may use an application 114 on the client device 104 (e.g., a slate computer, etc.) to perform a task, such as reading a web page of a website using a web browser application. The user 118 may want to navigate content of the web page or the website without substantial finger or hand movement. The user 118 may activate the enhanced navigation system 102 by performing a predefined gesture (such as a voice command—“enhanced navigation”, etc.) and/or actuating a control for the enhanced navigation system 102 that is included in the application 114 or shown in a display of the client device 104. Upon activation, the enhanced navigation system 102 may present a gesture panel at a position that may be determined based on an orientation of the client device 104 (e.g., portrait or landscape) and/or a current location of one or more hand parts (e.g., fingers, etc) of the user 118 detected on the display of the client device 104. The user 118 may navigate the content of the web page or the website by providing one or more predefined gestures within the gesture panel.

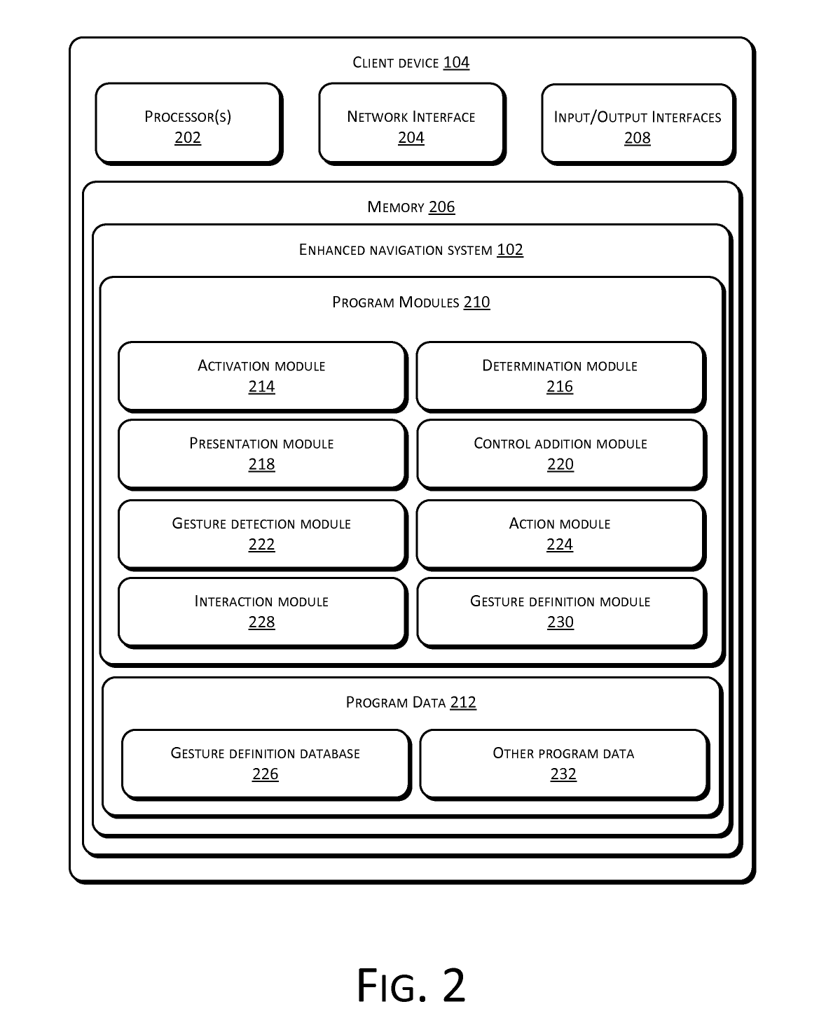

FIG. 2 illustrates the client device 104 that includes the enhanced navigation system 102 in more detail. In one embodiment, the client device 104 includes, but is not limited to, one or more processors 202 (which correspond to the one or more processors 110 in FIG. 1), a network interface 204, memory 206 (which corresponds to the memory 112 in FIG. 1), and an input/output interface 208. The processor(s) 202 is configured to execute instructions received from the network interface 204, received from the input/output interface 208, and/or stored in the memory 206.

The memory 206 may include computer-readable media in the form of volatile memory, such as Random Access Memory (RAM) and/or non-volatile memory, such as read only memory (ROM) or flash RAM. The memory 206 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Without loss of generality, a web browser application is used hereinafter as an example of the application 114 with which the user 118 is using or interacting using a touch-surface device. Content of the application 114 in this example corresponds to content of a web page of a website that is currently presented in the web browser application of the client device 104. It is noted, however, that the present disclosure is not limited thereto and can be applied to other applications, such as news applications, email applications, map applications, text processing applications, video or audio player applications, etc.

In one embodiment, the enhanced navigation system 102 may include program modules 210 and program data 212. The program modules 210 of the enhanced navigation system 102 may include an activation module 214 that waits for and/or listens to an activation gesture performed by the user 118. By way of example and not limitation, the activation gesture may include a predefined gesture such as a voice command, an actuation of a hard control on the client device 104, shaking or otherwise moving the device, and/or an actuation of a soft control (e.g., a button, an icon, etc.) presented in the application 114 and/or displayed in the display of the client device 104.

Upon detecting or receiving the activation gesture, the enhanced navigation system 102 may present one or more gesture panels to the user 118. In one embodiment, the enhanced navigation system 102 may include a determination module 216 that determines where the one or more gesture panels is/are to be placed in the display of the client device 104. In one embodiment, the determination module 216 may determine that one or more positions may be pre-designated or pre-set by the user 118, the application 114, the client device 104 and/or the enhanced navigation system 102. Examples of the one or more positions may include, but are not limited to, positions (such as corners) at the bottom of the display of the client device 104, positions (e.g., substantially middle parts, etc.) on the sides of the display of the client device 104, etc. The determination module 216 may determine which one or more pre-designated or pre-set positions is to be used based on, for example, an orientation of the client device 104.

Additionally or alternatively, in some embodiments, the determination module 216 may determine positions at which the one or more gesture panels is/are to be placed on the fly. By way of example and not limitation, the determination module 216 may determine a location where the user 118 is likely to hold the client device 104. In one embodiment, the determination module 216 may determine the location based on an orientation of the client device 104 and/or a touch sensor (e.g., a touch screen) of the client device 104. By way of example and not limitation, the determination module 216 may detect current positions of one or more hand parts (e.g., fingers, etc.) of the user 118 within or after a predetermined time period upon receiving the activation gesture, and determine positions of the one or more gesture panels to be placed based on the detected current positions of the one or more hand parts. For example, the determination module 216 may determine that respective positions of the one or more gesture panels to be centered at respective detected current positions of the one or more hand parts (e.g., one for left hand and one for right hand, etc.).

In response to determining the positions of the one or more gesture panels to be placed in the display of the client device 104, a presentation module 218 of the enhanced navigation system 102 may present the one or more gesture panels to the user 118. In one embodiment, a shape of the gesture panel may include rectangle, square, oval or another shape that has been predefined by the enhanced navigation system 102 and/or the user 118 in advance. Depending on the positions that the one or more gesture panels are to be placed, the presentation module 218 may present the one or more gesture panels on top of a part of the application 114, a part of content presented in the application 114 and/or other content or information displayed in the client device 104. In some embodiments, the presentation module 218 may present the one or more gesture panels without blocking the user 118 from viewing content behind or under the one or more gesture panels. For example, the presentation module 218 may present transparent or substantially transparent gesture panels with or without a line boundary indicating an area or region of a gesture panel.

In one embodiment, the presentation module 218 may present the one or more gesture panels to the user 118 by injecting a program to the application 114 and/or the content of the application 114. For example, the presentation module 218 may inject a JavaScript program to the web browser application and/or the web page of the website presented in the web browser application to present the one or more gesture panels on top of a part of the web page presented in the web browser application. The injected program (e.g., the JavaScript program) enables the presentation module 218 to present the one or more gesture panels for the application 114 (i.e., the web browser application in this example) and/or the content of the application 114 (e.g., the web page), without requiring an author and/or owner of the application 114 and/or the content to modify programming codes and/or functions on their parts, or at a server end (if the content is supplied from a server through the network 106).

In some embodiments, the enhanced navigation system 102 may be ready to accept navigation gestures from the user 118 within the one or more gesture panels. Additionally or alternatively, in some embodiments, the enhanced navigation system 102 may further include control addition module 220 that allows the user 118 to put or drag one or more controls of the application 114 to the one or more gesture panels. Upon detecting that the user 118 has put or dragged the one or more controls of the application 114 into the one or more gesture panels, the control addition module 220 may convert appearance of the one or more dragged controls into one or more simple icons (e.g., letter symbols representing the first letters of associated functions, etc.). Additionally or alternatively, the control addition module 220 may convert appearance of the one or more dragged controls into one or more partially transparent icons and/or controls with respective degrees of transparency predetermined by the enhanced navigation system 102 and/or the user 118.

In one embodiment, the enhanced navigation system 102 may include a gesture detection module 222 that detects and/or determine one or more user gestures received within the one or more gesture panels. For example, the user 118 may input a user gesture within a gesture panel that has been presented by the presentation module 218. In response to detecting the inputted user gesture, the gesture detection module 222 may determine whether the inputted user gesture corresponds to any one of a plurality of predefined user gestures. In one embodiment, the plurality of predefined user gestures may include, for example, user gestures that are preconfigured for a particular application (e.g., the web browser application) and/or a particular type of client device 104 by the enhanced navigation system 102. Additionally or alternatively, the plurality of predefined user gestures may include user gestures that have been predefined by the user 118 for actuating specific actions, functions and/or commands to the application 114 and/or the content presented in the application 114. Additionally or alternatively, the plurality of predefined user gesture may include user gestures that have been received (or downloaded) from another client device (not shown) and/or server (e.g., the one or more servers 108, etc.).

In one embodiment, the gesture detection module 222 may determine whether the inputted user gesture corresponds to any one of a plurality of predefined user gestures by comparing the inputted user gesture with the plurality of predefined user gestures. For example, the gesture detection module 222 may employ a conventional pattern matching algorithm to compare the inputted user gesture with the plurality of predefined user gestures, and determine a predefined user gesture having the highest similarity score for the inputted user gesture. The gesture detection module 222 may render the predefined user gesture having the highest similarity score as a match for the inputted user gesture. Additionally or alternatively, the gesture detection module 222 may further compare the similarity score to a predetermined threshold, and render the predefined user gesture having the highest similarity score as a match for the inputted user gesture if the similarity score is greater than or equal to the predetermined threshold. In some embodiments, if the similarity score is less than the predetermined threshold, the gesture detection module 222 may determine that the inputted user gesture is an unrecognized or undefined user gesture.

In one embodiment, in response to determining that the inputted user gesture corresponds to a predefined user gesture, the enhanced navigation system 102 (or an action module 224 of the enhanced navigation system 102) may perform an action, function and/or command based on the inputted or predefined user gesture. In some embodiments, the action module 224 may determine what action, function and/or command to be taken for the inputted user gesture based on one or more gesture definitions stored in a gesture definition database 226. In one embodiment, a gesture definition may include information describing a relationship or mapping between a user gesture and an action, function and/or command. Upon determining what action, function and/or command to be taken for the inputted user gesture from a corresponding gesture definition, the action module 224 may perform the determined action, function and/or command to the application 114 and/or the content of the application 114.

In some embodiments, in response to determining that the inputted user gesture does not correspond to any one of the plurality of predefined user gesture, the enhanced navigation system 102 may include a interaction module 228 that provides a response to the user 118 regarding a failure of recognizing the inputted user gesture. In one embodiment, the interaction module 228 may provide one or more options to the user 118. By way of example and not limitation, the one or more options may include, but are not limited to, providing a message or a dialog window indicating that the inputted user gesture is unrecognized or undefined and providing an opportunity to the user 118 to re-enter a user gesture within the gesture panel. Additionally or alternatively, in some embodiments, the one or more options may include providing a message or a dialog window asking whether the user 118 intends to define the unrecognized or undefined user gesture as a new user gesture and link the unrecognized or undefined user gesture to a new action, function and/or command.

In one instance, the interaction module 228 may receive an affirmative answer from the user 118 that the user 118 wants to define the unrecognized or undefined user gesture as a new user gesture, e.g., detecting or receiving a user click of “Yes” in the dialog window, etc. Although in this example, the user 118 is described to activate a process of gesture definition by inputting within the gesture panel a user gesture that is unknown or unrecognizable by the enhanced navigation system 102, in other embodiments, the enhanced navigation system 102 may additionally or alternatively provide a gesture definition control (e.g., a hard or soft button or a soft icon, etc.) for activating a gesture definition process in the application 114 and/or the client device 104. The user 118 may activate a gesture definition process by actuating the gesture definition control. Additionally or alternatively, the enhanced navigation system 102 may allow the user 118 to activate the gesture definition process by a predetermined gesture. Examples of the predetermined gesture for activating the gesture definition process may include, but are not limited to, providing a voice command or input such as “gesture definition”, inputting a specific or predetermined gesture (e.g., writing a “GD”) reserved for activating a process of gesture definition within the gesture panel, etc.

Regardless of how the user 118 activate the process of gesture definition, in response to determining that the user 118 wants to define a new user gesture to be associated with a new action (or function/command), the enhanced navigation system 102 may provide a gesture definition panel to the user 118 through a gesture definition module 230. In one embodiment, the gesture definition module 230 may receive or accept a new gesture that the user 118 wants to use for the new action within the gesture definition panel. Upon receiving the new gesture, the gesture definition module 230 may provide one or more actions, functions and/or commands that are provided and/or supported by the application 114 and/or the client device 104 to the user 118 for selection. In response to receiving a selection of an action, function and/or command from the user 118, the gesture definition module 230 may establish a mapping or relationship between the new gesture and the selected action, function and/or command, and add (or store) information of the mapping or relationship into the gesture definition database 226. Specifically, the gesture definition module 230 adds the new gesture as one of the plurality of predefined user gestures.

In some embodiments, the gesture definition module 230 may additionally or alternatively send or upload the information of the new gesture definition to a server of (e.g., a server of a cloud computing system or architecture, etc.) for storage and/or distribution of the gesture definition. For example, the gesture definition module 230 may send the information of the new gesture definition to the server 108 via the network 106. The server 108 may store the information of the new gesture definition and allow one or more users (including the user 118) to download the new gesture definition to one or more other client devices (not shown).

In one embodiment, the server 108 may further provide other gesture definition that may or may not be defined for the client device 104 and/or the application 114 that the user 118 is currently interacting with. For example, the server 108 may host a gesture definition website from which the user 118 may view or find a plurality of gesture definitions for a variety of different devices and/or applications. In one embodiment, the gesture definition module 230 and/or the gesture definition database 226 may know an address of the gesture definition website, and provide a link or information of the address of the gesture definition website so that the user 118 can visit the gesture definition website.

By way of example and not limitation, the user 118 may use the client device 104 to browse a web page of the gesture definition website hosted by the server 108. In one embodiment, the web page and/or the website may present a plurality of gesture definitions that are available for download to the client device 104 and/or the application 114. In some embodiments, the web page and/or the website may present gesture definitions that may or may not be specifically or originally defined for the client device 104 and/or the application 114. In one embodiment, the user 118 may note a gesture definition that is of interest to the user 118 in the web page. The user 118 may want to select and download the gesture definition to the client device 104 and/or the application 114. In one embodiment, the gesture definition website may provide a download link or control beside the selected gesture definition. Upon clicking the download link or control, the server 108 may enable a download of the selected gesture definition to the client device 104 and/or the application 114 through the gesture definition module 230. For example, the gesture definition module 230 may coordinate the download of the selected gesture definition to the client device 104 and/or the application 114, and store the selected gesture definition to the gesture definition database 226. Upon successful downloading the selected gesture definition, the gesture definition module 230 may notify the user 118 that the selected gesture definition is now ready to be used in the client device 104 and/or the application 114.

In one embodiment, prior to allowing or performing the download of the selected gesture definition to the client device 104, the server 108 may determine whether the selected gesture definition is originally defined for and/or uploaded from a device that is of a same type and/or capability as the client device 104 and/or an application that is of a same type and/or functionality as the application 114 of the client device 104. Additionally or alternatively, the server 108 may determine whether the selected gesture definition can be supported by the application 114 and/or the client device 104. For example, the server 108 may determine whether the action, function and/or command of the selected gesture definition is supportable (and/or acceptable) by and/or compatible with the application 114 and/or the client device 104. Additionally or alternatively, the server 108 may determine whether the client device 104 and/or the application 114 supports an action, a function and/or a command that produce(s) similar effect as that of the action, function and/or command of the selected gesture definition.

In one embodiment, if the server 108 determines that the selected gesture definition is supported (and/or acceptable) by and/or compatible with the client device 104 and/or the application 114, the server 108 may allow the download of the selected gesture definition to the client device 104 and/or the application 114 with the help of the enhanced navigation system 102 (or the gesture definition module 230). In some embodiments, if the server 108 determines that the selected gesture definition is not supported by the client device 104 and/or the application 114, the server 108 may deny the download and provide a message to the user 118 indicating a reason of the denial of the download of the selected gesture definition.

In other embodiments, if the server 108 determines that the selected gesture definition is not supported by the client device 104 and/or the application 114, the server 108 may attempt to adapt the selected gesture definition to a gesture definition that can be supported and/or accepted by the client device 104 and/or the application 114. For example, the server 108 may determine whether one or more actions, functions and/or commands that are supported by the client device 104 and/or the application 114 provide a same or similar effect as that of the action, function and/or command of the selected gesture definition. In an event that an action, function and/or command producing a same or similar effect as that of the action, function and/or command of the selected gesture definition is found, the server 108 may adapt the selected gesture definition to a gesture definition supportable and/or acceptable by the client device 104 and/or the application 114, for example, by replacing the original action, function and/or command of the selected gesture definition by the found action, function and/or command. The server 108 may then allow the download of the adapted gesture definition to the client device 104 and/or the application 114.

Although the foregoing embodiments describe that the server 108 performs operations of determination of whether the selected gesture definition is supported and/or accepted by the client device 104 and/or the application 114, and adaptation of the selected gesture definition to a gesture definition that is supported and/or accepted by the client device 104 and/or the application 114, in other embodiments, these operations may be performed by the enhanced navigation system 102 upon downloading the selected gesture definition to the client device 104 and/or the application 114. By way of example and not limitation, upon downloading the selected gesture definition, the gesture definition module 230 may determine whether the action, function and/or command of the selected gesture definition is an action, function and/or command supported by the client device 104 and/or the application 114. If the action, function and/or command of the selected gesture definition is supported by the client device 104 and/or the application 114, the gesture definition module 230 may add the selected gesture definition to the gesture definition database 226 for future use by the user 118.

If the action, function and/or command of the selected gesture definition is not supported by the client device 104 and/or the application 114, the gesture definition module 230 may determine whether one or more actions, functions and/or commands that are supported by the client device 104 and/or the application 114 provide a same or similar effect as that of the action, function and/or command of the selected gesture definition can be found. If an action, function and/or command producing a same or similar effect as that of the action, function and/or command of the selected gesture definition is found, the gesture definition module 230 may adapt the selected gesture definition to a gesture definition supportable and/or acceptable by the client device 104 and/or the application 114, for example, by replacing the original action, function and/or command of the selected gesture definition by the found action, function and/or command.

Additionally or alternatively, prior to adapting the selected gesture definition to a gesture definition supportable and/or acceptable by the client device 104 and/or the application 114, the gesture definition module 230 may present information related to this adaptation of the selected gesture definition to the user 118 and allow the user 118 to provide feedback on this adaptation. For example, if more than one action, function and/or command that are available for adaptation, the gesture definition module 230 may present these actions, functions and/or commands to the user 118 and wait for user selection of an action, function and/or command for replacing the original action, function and/or command of the selected gesture definition. Upon receiving a user selection, the gesture definition module 230 may replace the original action, function and/or command of the selected gesture definition by the selected action, function and/or command. In some embodiments, the gesture definition module 230 may perform adaptation of the selected gesture definition to the client device 104 and/or the application 114 with or without input and/or intervention of the user 118.

In some embodiments, the enhanced navigation system 102 and/or the server 108 may receive information from the user 118 that defines a group of multiple client devices 104 that may be used by or belonged to the user 118 and/or one or more other users for synchronizing one or more new gesture definitions with the client device 104. The multiple client devices 104 may or may not include the instant client device 104 of the user 118. For example, in response to receiving one or more new gesture definitions by the enhanced navigation system 102 of the instant client device 104 of the user 118 (or the server 108), the enhanced navigation system 102 (or the server 108) may propagate the one or more new gesture definitions to other devices included in the group of multiple client devices 104 through the network 106. Additionally or alternatively, the enhanced navigation system 102 (or the server 108) may perform one or more foregoing operations such as adaptation of the gesture definitions for one or more client devices of the group.

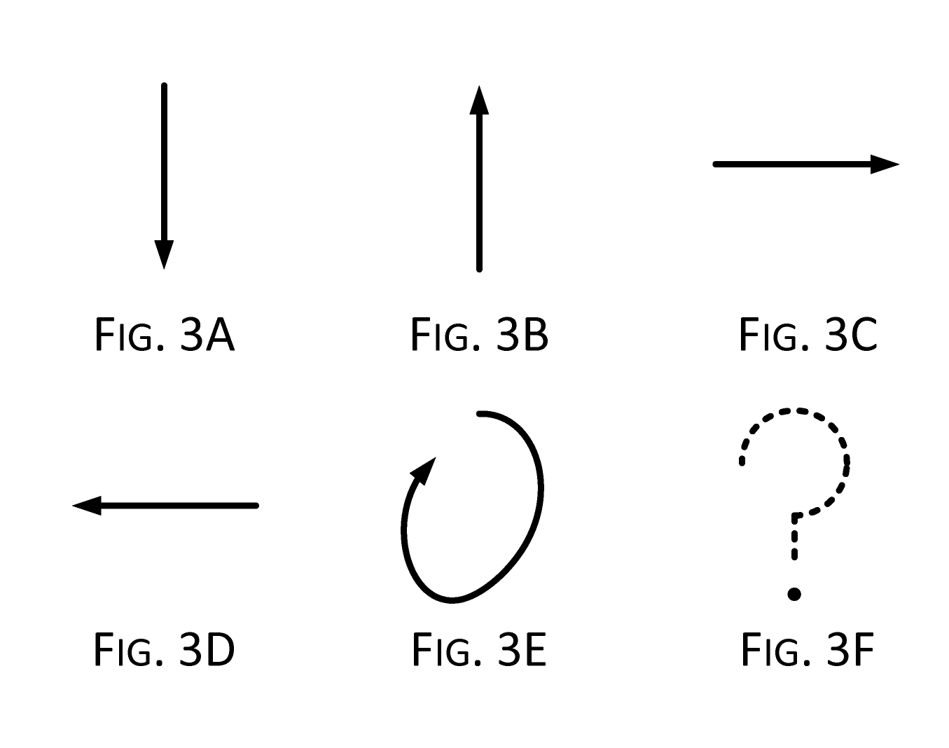

In one embodiment, the enhanced navigation system 102 may further include other program data 232. The other program data 232 may include log data storing information including activities of downloading and uploading gesture definition, activities of navigation using the gesture panel for the application 114 (and other applications provided in the client device 104), activities of defining gesture definition, etc. The enhanced navigation system 102 may employ this information in the log data 232 to provide additional service to the user 118, such as recommending new gesture definitions to the user 118 for download based on download activities of gesture definitions, improving recognition of input gestures from the user 118 based on navigation activities using the gesture panel, etc. FIGS. 3A-3F illustrate example user gestures that may be defined for use in the gesture panel. The example user gestures shown in FIGS. 3A-3F include user-defined gestures for browsing a web page including threads and/or articles of one or more forums, for illustrative example. For example, FIG. 3A represents a gesture for scrolling down the web page while FIG. 3B represents a gesture for scrolling up the web page. FIG. 3C shows a gesture for browsing a next article or thread while FIG. 3D shows a gesture for browsing a previous article or thread. FIG. 3E represents a gesture to refresh the web page and FIG. 3F represents a gesture for another specific command that has been defined by the user 118 and/or the enhanced navigation system 102.

Additionally or alternatively, the enhanced navigation system 102 may provide a plurality of gesture panels and combine gestures performed by the user 118 on the plurality of gesture panels for actuating one or more commands. For example, the enhanced navigation system 102 may provide two gesture panels, one for the left hand and one for the right hand of the user 118. The user 118 may perform a gesture (e.g., drawing a down arrow as shown in FIG. 3A, etc.) on the right-hand gesture panel. The enhanced navigation system 102 may recognize this gesture on the right-hand gesture panel as a command of scrolling down the web page if (or only if) the user 118 holds the left-hand gesture panel at the same time. For another example, the user 118 may want to click on a hyperlink under the right-hand gesture panel. The user 118 may be able to select the hyperlink under the right-hand gesture panel without causing the enhanced navigation system 102 to misinterpret this selection as a command on the right-hand gesture panel if, for example, the user does not hold onto the left-hand gesture panel.

Additionally or alternatively, the enhanced navigation system 102 may actuate different commands for a same gesture performed on different gesture panels. For example, the enhanced navigation system 102 may interpret a certain gesture (such as the moving-down gesture as shown in FIG. 3A, for example) performed on one gesture panel (e.g., the left-hand gesture panel) as a first command (such as moving to a next hyperlink) whiling recognizing this same gesture performed on another gesture panel (e.g., the right-hand gesture panel) as a different command (e.g., scrolling down the web page, etc.).

### Exemplary Methods

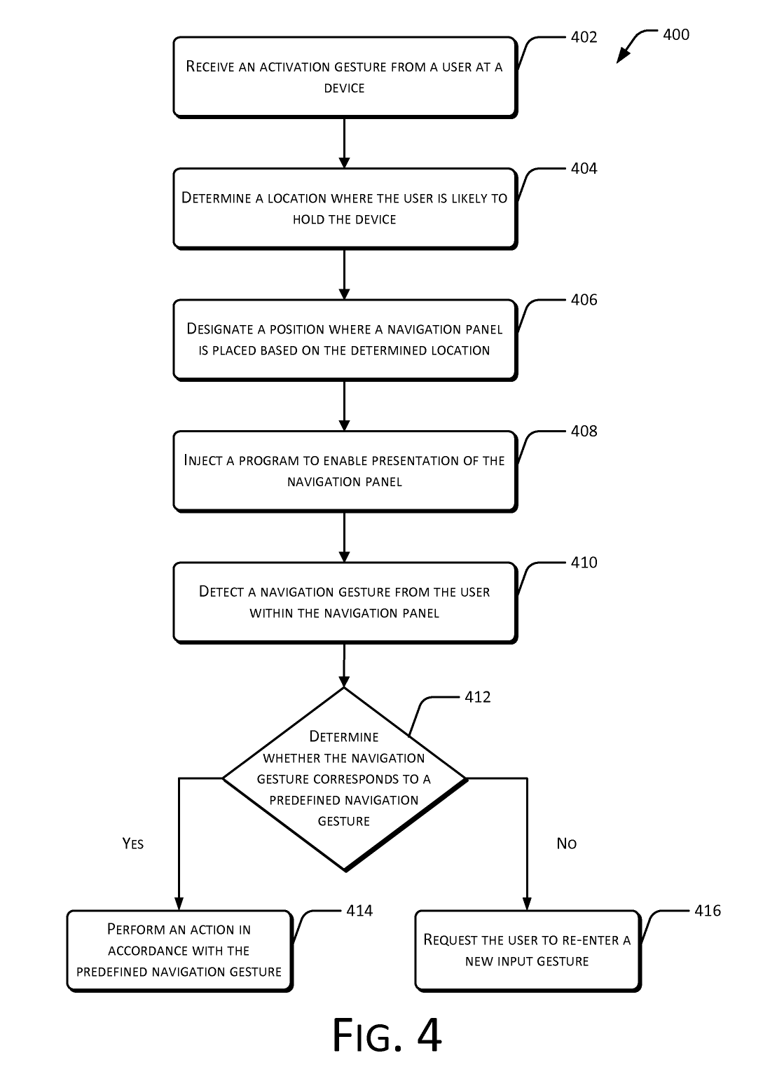

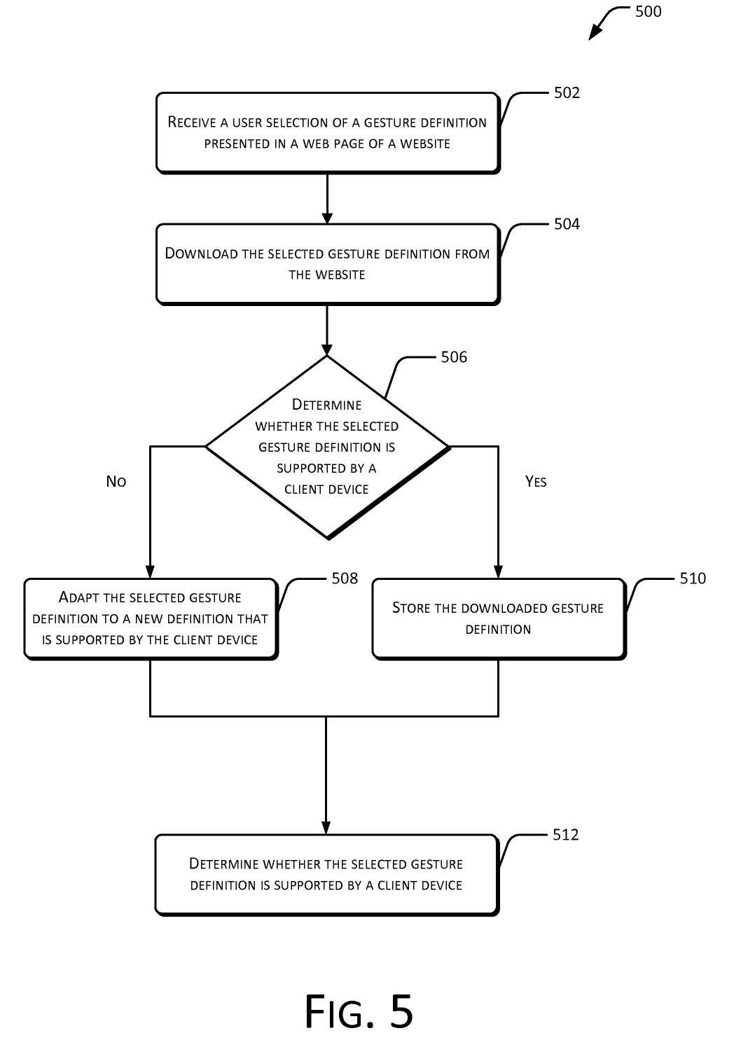

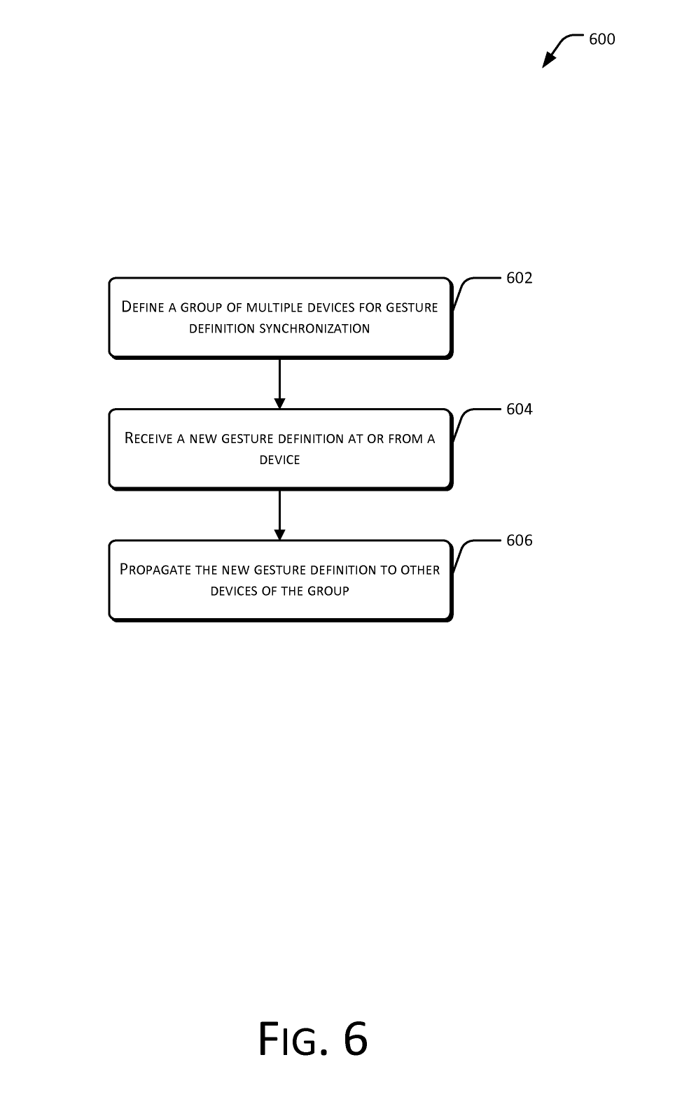

FIG. 4 is a flow chart depicting an example method 400 of launching a gesture panel for enhanced navigation. FIG. 5 is a flow chart depicting an example method 500 of downloading a gesture definition from one device to another device. FIG. 600 is a flow chart depicting an example method of synchronizing a gesture definition from a first device to one or more other second devices. The methods of FIG. 4, FIG. 5 and FIG. 6 may, but need not, be implemented in the environment of FIG. 1 and using the system of FIG. 2. For ease of explanation, methods 400, 500 and 600 are described with reference to FIGS. 1 and 2. However, the methods 400, 500 and 600 may alternatively be implemented in other environments and/or using other systems.

Methods 400, 500 and 600 are described in the general context of computer-executable instructions. Generally, computer-executable instructions can include routines, programs, objects, components, data structures, procedures, modules, functions, and the like that perform particular functions or implement particular abstract data types. The method can also be practiced in a distributed computing environment where functions are performed by remote processing devices that are linked through a communication network. In a distributed computing environment, computer-executable instructions may be located in local and/or remote computer storage media, including memory storage devices.

The exemplary method is illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 4, at block 402, the application 114 (and/or the enhanced navigation system 102 if already activated) receives a user gesture to initiate a presentation of a navigation panel in a display of the client device 104. In one embodiment, the user gesture may include, but is not limited to, activating a soft button on a toolbar of the application 114 (e.g., a button on a toolbar of a browser application, etc.), a hotkey, a voice command or input, or a combination thereof. The display of the client device 104 currently present content of the application 114 (e.g., a web page of a website in a web browser application). In one embodiment, the application 114 with the enhanced navigation system 102 may accept one or more navigation gestures from the user 118 to navigate the web page and/or the website, for example, through the navigation panel. Depending on whether part or all of the enhanced navigation system 102 is built into an operating system or the application 114 of the client device 104, code or program injection (e.g., injection of JavaScript® codes or program into the web page) may be performed upon receiving the user gesture to activate or initiate functions of the enhanced navigation system 102. In some embodiments, the enhanced navigation system 102 may determine whether the website supports the code injection and downloads or determine available user gesture definitions that are supported by the website.

At block 404, the enhanced navigation system 102 may determine a location where the user 118 is likely to hold the client device 104.

At block 406, the enhanced navigation system 102 may designating a position where the navigation panel to be presented based on the determined location.

At block 408, if part or all of the enhanced navigation system 102 is built into the operating system or the application 114 and no code or program injection has been performed at block 402, the enhanced navigation system 102 may inject a program (e.g., a JavaScript program) into the content of the application 114 (e.g., the web page) without modifying programming codes associated with the website at a server end. In one embodiment, the injected program enables an overlaying of the navigation panel on top of a part of web page at the designated position. In some embodiments, the navigation panel may be transparent without blocking the user 118 to view the part of the web page presented in the display.

At block 410, the enhanced navigation system 102 may detect a navigation gesture from the user 118 within the navigation panel.

At block 412, the enhanced navigation system 102 may determine whether the detected navigation gesture corresponds to a predefined navigation gesture of a plurality of predefined navigation gestures.

At block 414, in response to determining that the detected navigation gesture corresponds to a predefined navigation gesture of the plurality of predefined navigation gestures, the enhanced navigation system 102 may perform an action in accordance with the predefined navigation gesture.

At block 416, in response to determining that the detected navigation gesture does not correspond to any of the plurality of predefined navigation gestures, the enhanced navigation system 102 may request the user 118 to re-enter a new input gesture for recognition.

Referring back to FIG. 5, at block 502, the enhanced navigation system 102 receives a user selection of a gesture definition of a plurality of gesture definition presented in a web page of a website. The website or the web page presents information of a plurality of gesture definitions that are available for download to the client device 104 of the user 118. Each gesture definition includes information defining a relationship between a user gesture and an action actuated upon receiving the user gesture.

At block 504, the enhanced navigation system 102 downloads the selected gesture definition from the website.

At block 506, prior to enabling the user 118 to use the selected gesture definition in the client device 104, determining whether the selected gesture definition is supported by the client device 104.

At block 508, in response to determining that the selected gesture definition is not supported by the client device 104, the enhanced navigation system 102 adapts the selected gesture definition to a new gesture definition that is supported by the client device 104. The enhanced navigation system 102 may further store the new gesture definition in the gesture definition database 226.

At block 510, in response to determining that the selected gesture definition is supported by the client device 104, the enhanced navigation system 102 stores the downloaded gesture definition in the gesture definition database 226.

At block 512, the enhanced navigation system 102 enables the new gesture definition for use by the user 118 in the client device 104 and/or the application 114.

Referring back to FIG. 6, at block 602, the enhanced navigation system 102 of the client device 104 or the server 108 may receive information about a group of multiple devices from the user 118. For example, the user 118 may define a group of multiple devices for gesture definition synchronization.

At block 604, the enhanced navigation system 102 of the client device 104 (or the server 108) may detect or receive a new gesture definition at (or from) the client device 104.

At block 606, in response to detecting or receiving the new gesture definition, the enhanced navigation system 102 (or the server 108) may propagate the new gesture definition to other devices of the group through, for example, the network 106. In some embodiments, prior to propagating the new gesture definition to other devices of the group, the enhanced navigation system 102 (or the server 108) may determine whether the new gesture definition is supportable by or compatible with a device of the other devices of the group. If the enhanced navigation system 102 (or the server 108) determines that the new gesture definition is not supportable by or compatible with the device of the other devices of the group, the enhanced navigation system 102 (or the server 108) may perform an adaptation of the new gesture definition prior to propagating the new gesture definition to the device of the other devices of the group. Alternatively, the enhanced navigation system 102 (or the server 108) may propagate the new gesture definition to the device of the other devices with an adaptation instruction. The adaptation instruction may indicate that the new gesture definition is not compatible with the device of the other devices and direct the device of the other devices to perform an adaptation of the new gesture definition itself.

Although the above acts are described to be performed by the enhanced navigation system 102, one or more acts that are performed by the enhanced navigation system 102 may be performed by the client device 104 or other software or hardware of the client device 104 and/or any other computing device (e.g., the server 108). For example, the client device 104 may detect an activation gesture from the user 118 and activate the enhanced navigation system 102. The server 108 may then analyze an input gesture given by the user 118 within the gesture panel and prompt the client device 104 to perform an appropriate action for the input gesture.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media such as one or more computer storage media.

### CONCLUSION

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A device comprising:
one or more processors;
a display;
memory storing executable instructions that, when executed by the one or more processors, configure the one or more processors to perform acts comprising:
receiving a user gesture to initiate a presentation of a navigation panel in the display of the device, the display currently presenting a web page of a website and the navigation panel configured to accept one or more navigation gestures from a user to navigate the web page and/or the website;
determining a location where a user is likely to hold the device;
designating, based on the determined location, a position where the navigation panel is to be presented;
injecting a program into the web page currently presented by the display without modifying programming codes associated with the website at a server end, the injecting enabling an overlaying of the navigation panel on top of a part of web page at the designated position, the navigation panel being transparent without blocking the part of the web page on which the navigation panel is overlaid;
detecting a navigation gesture from the user within the navigation panel; and
in response to detecting the navigation gesture, performing an action in accordance with the navigation gesture.

2. The device as recited in claim 1, wherein the navigation gesture comprises a predefined gesture.

3. The device as recited in claim 1, wherein the navigation gesture comprises a gesture defined by the user.

4. The device as recited in claim 1, wherein determining the location where the user is likely to hold the device is based on an orientation of the device.

5. The device as recited in claim 1, wherein determining the location where the user is likely to hold the device is based on a touch sensor of the device.

6. One or more computer-readable media storing executable instructions that, when executed by one or more processors, configure the one or more processors to perform acts comprising:
detecting a first user gesture from a user to actuate a predetermined control on a web browser application displayed in a display of a device, the web browser application presenting a web page of a website;
in response to detecting the first user gesture,
injecting a program to the web page without modifying programming codes associated with the website at a server end, the injecting enabling presenting a transparent gesture panel at a position on the display of the device, wherein the presenting comprises overlaying the transparent gesture panel on top of the web browser application at the position of the display of the device;
receiving a second user gesture from the user within the transparent gesture panel; and
enabling a navigation of the web page or the website by the user based on the second user gesture.

7. The one or more computer-readable media as recited in 6, the acts further comprising:
determining whether the second user gesture corresponds to a user gesture predefined for the web browser application; and
in response to determining that the second user gesture corresponds to a user gesture predefined for the web browser application, performing an action in accordance with the predefined user gesture to enable the navigation of the web page or the website by the user.

8. The one or more computer-readable media as recited in claim 6, the acts further comprising:
determining whether the second user gesture corresponds to a user gesture predefined for the web browser application; and
in response to determining that the second user gesture does not correspond to a user gesture predefined for the web browser application, prompting the user to resubmit a new user gesture or providing a message to the user to ask whether the user wants to define a new command based on the second user gesture.

9. The one or more computer-readable media as recited in claim 6, further comprising:
determining a location where the user is likely to hold the device; and
designating, based on the determined location, the position where the transparent gesture panel is presented.

10. The one or more computer-readable media as recited in claim 6, wherein determining the location where the user is likely to hold the device is based on an orientation of the device.

11. The one or more computer-readable media as recited in claim 6, wherein determining the location where the user is likely to hold the device is based on a touch sensor of the device.

12. A method comprising:
under control of one or more processors configured with executable instructions:
detecting a user gesture associated with an application that is currently presented on a display of a device;
determining a location where a user is likely to hold the device;
designating, based on the determined location, a position where a gesture panel is to be presented; and
overlaying the gesture panel on top of a page of the application at a designated position on the display of the device, the gesture panel comprising an area that is dedicated to accept one or more other user gestures for navigating the page of the application.

13. The method as recited in claim 12, further comprising:
detecting another user gesture on the gesture panel;
determining whether the other user gesture on the gesture panel corresponds to a predefined user gesture of a plurality of predefined user gestures; and
in response to determining that the other user gesture corresponds to a predefined user gesture of the plurality of predefined user gestures, performing an action on the application in accordance with the predefined user gesture.

14. The method as recited in claim 12, further comprising:
detecting another user gesture on the gesture panel that is overlaid on the page of the application;
determining whether the other user gesture on the gesture panel corresponds to a predefined user gesture of a plurality of predefined user gestures; and
in response to determining that the other user gesture does not correspond to any of the plurality of predefined user gestures, prompting a user with one or more options, the one or more options comprising:
indicating to the user that the other user gesture is undefined;
requesting the user to provide a new user gesture; and/or
asking the user whether a new command based on the other user gesture is to be defined.

15. The method as recited in claim 12, wherein the application comprises a web browser application and the page of the application comprises a web page of a website.

16. The method as recited in claim 15, further comprising in response to detecting the user gesture associated with the application, injecting a program in the page of the application, the injecting causing the overlaying of the gesture panel on top of the page of the application.

17. The method as recited in claim 16, wherein the injecting enables overlaying the gesture panel on the page of the application without modifying programming codes associated with the website at a server end.

18. The method as recited in claim 12, further comprising:
in response to detecting the user gesture associated with the application, determining one or more hyperlinks in the page of the application; and
extracting the one or more hyperlinks to be displayed within the gesture panel.

19. The method as recited in claim 12, further comprising:
in response to detecting the user gesture associated with the application, determining one or more hyperlinks in the page of the application; and
extracting the one or more hyperlinks to be displayed within a hyperlink panel that is different from the gesture panel and located at another predetermined position on the display of the device.

20. The method as recited in claim 12, further comprising enabling a user to move the gesture panel to another position on the display of the device.

21. The method as recited in claim 12, wherein determining the location where the user is likely to hold the device is based on an orientation of the device.

22. The method as recited in claim 12, wherein determining the location where the user is likely to hold the device is based on a touch sensor of the device.

23. The method as recited in claim 12, wherein the detected user gesture comprises: actuation of a soft control of the application and/or actuation of a hard control of the device.

24. The method as recited in claim 12, wherein the gesture panel is transparent, allowing a user to view content presented on the display of the device under the gesture panel.

25. A method comprising:
under control of one or more processors configured with executable instructions:
receiving a gesture definition from a first device, the gesture definition comprising information defining a relationship between a user gesture and an action actuated upon receiving the user gesture at the first device; and
sending information associated with the gesture definition to a second device.

26. The method as recited in claim 25, wherein sending the information associated with the gesture definition to the second device is performed in response to receiving a request from the second device.

27. The method as recited in claim 25, wherein sending the information associated with the gesture definition to the second device is performed automatically upon receipt of the gesture definition from the first device.

28. The method as recited in claim 25, wherein sending the information associated with the gesture definition to the second device is performed periodically.

29. The method as recited in claim 25, further comprising:
determining whether the second device is a same device type as the first device;
in response to determining that the second device is not the same device type as the first device, adapting the gesture definition received from the first device to a gesture definition supported by the second device.

30. The method as recited in claim 25, further comprising:
determining whether an application of the second device is a same application of the first device for which the gesture definition is originally defined;
in response to determining that the application of the second device is not the same application of the first device, adapting the gesture definition received from the first device to a gesture definition supported by the application of the second device.

31. The method as recited in claim 25, wherein the adapting comprises replacing the action of the gesture definition by a new action that produces a same effect and is supported by the application of the second device.

32. A device comprising:
one or more processors;
memory storing executable instructions that, when executed by the one or more processors, configure the one or more processors to perform acts comprising:
presenting a web page of a website to a user, the web page comprising information of a plurality of gesture definitions available for download to a device of the user, each gesture definition comprising information defining a relationship between a user gesture and an action actuated upon receiving the user gesture;
receiving a user selection of a gesture definition presented on the web page;
downloading the selected gesture definition from the website;
prior to enabling the user to use the selected gesture definition in the device of the user, determining whether the selected gesture definition is supported by the device;
in response to determining that the selected gesture definition is not supported by the device, adapting the selected gesture definition to a new gesture definition that is supported by the device; and
enabling the new gesture definition for use by the user in the device.

33. The device as recited in claim 32, wherein the adapting comprises:
determining one or more actions supported by the device that produce a same or similar effect as an effect of an action of the selected gesture definition;
replacing the action of the selected gesture definition by one of the one or more determined actions supported by the device.

34. The device as recited in claim 32, wherein the adapting further comprises: enabling the user to select the one of the one or more determined actions supported by the device for replacing the action of the selected gesture definition.

35. A method comprising:
under control of one or more processors configured with executable instructions:
defining a group of multiple devices;
receiving one or more gesture definitions from a device of the group; and
propagating the one or more received gesture definitions to other devices of the group.

36. The method as recited in claim 35, wherein propagating the one or more received gesture definitions to the other devices of the group is performed over a network.

37. The method as recited in claim 35, wherein prior to propagating the one or more received gesture definitions to other devices of the group, the method further comprises determining whether a gesture definition the one or more received gesture definitions of is compatible with a device of the other devices.

38. The method as recited in claim 37, further comprising:
in response to determining that the gesture definition is not compatible with the device of the other devices, adapting the gesture definition to a gesture definition that is compatible with the device of the other devices;
propagating the adapted gesture definition to the device of the other devices.

39. The method as recited in claim 37, further comprising in response to determining that the gesture definition is not compatible with the device of the other devices, propagating the gesture definition to the device of the other devices with an adaptation instruction, the adaptation instruction indicating that the gesture definition is not compatible with the device of the other devices and directing the device of the other devices to perform an adaptation of the gesture definition.

40. The method as recited in claim 35, wherein the multiple devices comprise devices of different types.
